(19) United States
(12) Patent Application Publication
(10) Pub. No.: US 2008/0114940 A1
(43) Pub. Date: May 15, 2008

(54) Data Processor

(75) Inventor: Masayuki Ito, Tokyo (JP)

Correspondence Address: MILES & STOCKBRIDGE PC, 1751 PINNACLE DRIVE, SUITE 500, MCLEAN, VA, 22102-3833, US

(73) Assignee: RENESAS TECHNOLOGY CORP., Tokyo (JP)

(21) Appl. No.: 11/663,592

(22) PCT Filed: Sep. 30, 2004
(86) PCT No.: PCT/JP04/14353

§ 371 Date: Mar. 23, 2007

(51) Int. Cl. G06F 12/00

(52) U.S. Cl. 711/128; 711/207

(57) ABSTRACT

In regard to a set associative cache memory (21) having ways coincident in number with entries of TLB, the ways each have a storage capacity in its data part (DAT); the storage capacity corresponds to a page size, which is a unit of address translation by TLB. Each way has no tag memory as an address part nor tag. The entries (ETY0-ETY7) of TLB are in a one-to-one correspondence with ways (WAY0-WAY7) of the cache memory. Only the data in a region subjected to mapping to a physical address defined by an address translation pair of TLB can be cached in the corresponding way. According to a TLB hit signal produced with a logical product of the result of the comparison of a virtual page address of TLB and an effective bit of TLB, an action for a cache data array is selected for only one way. The cache effective bit of the way with the action selected is used as a cache hit signal.

### FIELD OF THE INVENTION

The present invention relates to a data processor having a cache memory and an address translation buffer.

### BACKGROUND OF THE INVENTION

In regard to cache memories, there are the following methods as a mapping method for associating data in an external memory with data in a cache memory in blocks having a certain size: a direct mapping method; a set associative method; and a full associative method. When the size of each block is “B” bytes, the number of blocks in a cache memory is “c,” the number “m” of the block which contains bytes of an address “a” of an external memory is an integral part of “a/B.” In the direct mapping method, the block of the external memory with the number “m” is uniquely mapped to a block with a number derived from the expression “m mod c” in the cache memory. Further, in the direct mapping, when plural blocks possibly allocated to the same block in the cache memory are used at the same time, a collision will occur, reducing the cache hit rate. That is, even with different addresses, the same block (cache line) is often indexed. In contrast, the full associative method is to map any block in the external memory to any block in the cache memory. However, in the full associative method, associative retrieval needs to be performed for all the blocks of the cache memory at each access, which is hard to realize with a practical cache capacity. Therefore, the set associative method that is in-between of the methods is generally put to practical use. In the set associative method, a collection of n (n=2, 4, 8 or so) blocks in the cache memory is defined as a set, and the direct mapping method is applied to the set while the full associative mapping is applied to the blocks (i.e. ways) in the set, whereby the merits of both methods will be used. Coming from the value n, this method is called an n way set associative method.

In a 4-way set associative method, tags, effective bits and data are read out from cache lines of four ways indexed by an index bit of a virtual address, first. In a cache according to a physical address tag method, which is a practical cache method, a physical address resulting from the translation of a virtual address by an address translation buffer (TLB) is compared with a tag of each way. Then the way having a tag in agreement with the physical address and the effective bit “1” will be a way making a cache hit. Selecting data from a data array of the way making a cache hit makes it possible to supply the data required by the CPU. The case where no hit is found for all the ways is a cache miss. In this case, it is necessary to access a low hierarchical cache memory or an external memory to gain effective data. It is noted that the ideas of the full associative, set associative, and direct mappings can be adopted for an arrangement of TLB independently of a cache.

In the prior-art search after the completion of the invention, a patent document, JP-A-2003-196157 has been obtained, which presents the description concerning the invention for efficient judgments about a TLB hit and a cache hit in a microprocessor including a TLB and a cache memory as follows. That is, a TLB/cache serving as both a TLB and a cache memory is arranged. In translation from a virtual address to a physical address, the TLB/cache is indexed with the virtual address, and a tag is read out. Then, the tag thus read out is compared with high-order bits of the virtual address. A cache hit signal is generated based on a signal resulting from the comparison and an effective flag CV. The technique is characterized by performing judgments about a cache hit and a TLB hit at a time in one comparing action, and a direct map therefor is shown as an example. In the case of a set associative form, two or more ways are made to work in parallel as a matter of course, and judgments about a cache hit and a TLB hit are performed at a time for each way. Particularly, a cache line of data can be made equal to a page size, which is an address translation unit. Therefore, the unit for reading and writing of a cache line with an index ranges e.g. 1 to 4 kilobytes, which can represent several tens-fold or larger in comparison to a typical size such as 32 bytes.

### SUMMARY OF THE INVENTION

The inventor has studied the power consumption by a set associative cache memory. For example, a 4-way set associative cache memory requires that tags for four ways should be read out followed by performing judgment of a cache hit each time an access to the memory occurs. The data for the four ways have been previously read out at a time. Then, the data of the way hit with a signal for the cache hit judgment is selected. Therefore, the inventor found that it is required to read out all the tag memories and data memories for the four ways, which makes larger electric power consumption.

The need for reduction in power consumption of a data processor has been growing increasingly with an increase in operation frequency owing to the scaling down of a process and an increase in scale of logic. This has become a particularly large problem for a data processor which needs a battery-driven system and low-cost packaging.

Based on the background, the inventor has considered a measure to avoid needless readout of a cache memory which consumes a large electric power in operation. From the viewpoint of a cache hit rate, set associative cache memories having two to eight ways have been used in most cases. While a set associative cache memory requires that tag and data arrays of all the ways should be read out, what is actually used is only the data read out from one way. Further, it is natural that successive regions in an external memory undergo caching. Therefore, there is a tendency such that identical physical page addresses (or physical page address numbers) are registered on lots of the tags, and the physical addresses conform to the physical page number of TLB. Hence, the inventor has acquired the idea of arranging the physical page number of TLB so as to double as a tag of cache, and a data array of only one way in the set associative cache memory is activated according to a hit signal of TLB. The idea that occurred from JP-A-2003-196157 is as follows. That is, in order to perform judgments of a TLB hit and a cache hit efficiently, the physical page number of TLB is made to double as a tag of a cache.

Therefore, it is an object of the invention in association with a data processor having a set associative cache memory and an address translation buffer to reduce electric power consumption by the set associative cache memory.

The above-described and other objects of the invention and a novel feature thereof will be apparent from the descriptions herein and the accompanying drawings.

The outlines of representatives of a data processor disclosed herein will be described below briefly. In regard to a set associative cache memory having ways coincident in number with entries of TLB, the ways each have a storage capacity in its data part; the storage capacity corresponds to a page size, which is a unit of address translation by TLB. Each way has no tag memory as an address part nor tag. The entries of TLB are in a one-to-one correspondence with ways of the cache memory. Only the data in a region subjected to mapping to a physical address defined by an address translation pair of TLB can be cached in the corresponding way. According to a TLB hit signal produced with a logical product of the result of the comparison of a virtual page address of TLB and an effective bit of TLB, an action for a cache data array is selected for only one way. The cache effective bit of the way with the action selected is used as a cache hit signal. The invention will be further described below according to plural aspects.

[1] A data processor according to an aspect of the invention has an address translation buffer and a cache memory in a set associative form, wherein the address translation buffer has n entry fields for each storing an address translation pair; the cache memory has n ways in a one-to-one correspondence with the entry fields; and the n ways each include a data field having a storage capacity equal to a page size which is a unit of address translation. The address translation buffer outputs a result of associative comparison for each entry field to the corresponding way. The way starts a memory action in response to an associative hit of the input associative comparison result. According to the above-described means, only one way is activated in response to an associative hit of TLB. Therefore, it is possible to avoid that in the set associative cache memory, tag and data arrays of all the ways are read out in parallel to make the way work, thereby contributing to the reduction in electric power consumption.

A specific form of the invention is as follows. The address translation pair has information composed of a combination of a virtual page address and a physical page address corresponding to the virtual page address, and a physical page address of data which the data field keeps is identical with the physical page address which the address translation pair of the corresponding entry field keeps. Further, there is no need for the cache memory to have an address tag field which would make a mate to the data field.

Still further in the form, the address translation buffer compares an input address targeted for the translation with the virtual page address of each entry field, and the address translation buffer serves the way corresponding to the entry field with a notice of way hit on condition that the entry field matched as a result of the comparison is valid, and the notice of way hit shows an associative hit, which is a result of the associative comparison.

The data processor further includes a control unit (2, 24) which replaces the entry of the address translation buffer when associative comparisons by the address translation buffer all result in associative miss. In the data processor, the control unit nullifies a data field of the way of the cache memory corresponding to the entry to be replaced when replacing the entry of the address translation buffer. When nullifying the data field of the way of the cache memory corresponding to the entry to be replaced, if the data field is targeted for copy back and has data, the control unit further writes the data back to a memory on a low hierarchical side.

[2] A data processor according to another aspect of the invention has an address translation buffer and a cache memory in a set associative form, wherein the address translation buffer has n entry fields for each storing an address translation pair; the cache memory has n ways in a one-to-one correspondence with the entry fields; and the ways are each allocated to store data of a physical page address which the corresponding entry field keeps. The ways start a memory action on condition that associative comparisons concerning the corresponding entry fields result in an associative hit. Therefore, it is possible to avoid that in the set associative cache memory, tag and data arrays of all the ways are read out in parallel to make the way work, thereby contributing to the reduction in electric power consumption.

A specific form of the invention is as follows. The data processor further has a control unit which replaces the entry of the address translation buffer when associative comparisons concerning all the entry fields result in associative miss, wherein the control unit nullifies cache data of the way of the cache memory corresponding to the entry to be replaced when replacing the entry of the address translation buffer. When nullifying data of the way of the cache memory corresponding to the entry to be replaced, if the data which the way has is to be copied back, the control unit further writes the data back to a memory on a low hierarchical side.

[3] A data processor according to another aspect of the invention has an address translation buffer and a cache memory in a set associative form, wherein the address translation buffer has n entry fields for each storing an address translation pair, and a prediction circuit for predicting the entry field which will make a translation hit at a time of address translation; the cache memory has n ways in a one-to-one correspondence with the entry fields; and the ways are each allocated to store data placed at a physical page address which the corresponding entry field keeps. Further, the ways start a memory action on condition that the corresponding entry field is a prediction region of an address translation hit. The cache memory creates a cache hit on condition that prediction on the address translation hit matches up with an actual address translation result.

In the control form to activate corresponding one of the ways in response to an associative hit of TLB, the timing when the action of the one way is started is after the result of associative retrieval of TLB has been obtained. On this account, the time required until the start of the action of indexing a cache memory is longer in comparison to a control form to index a cache memory in parallel to the associative retrieval of TLB. However, when the action of indexing a cache memory is started in advance according to the result of prediction by the prediction circuit, delay of the start of the action can be made smaller. Because a cache hit in the caching action started in advance is based on the condition where the prediction on the address translation hit matches with an actual address translation result, a mistaken prediction never makes the caching action valid.

[4] A data processor according to still another aspect of the invention has an address translation buffer and a cache memory in a set associative form having ways, wherein the address translation buffer has an address translation pair keeping virtual page address information and physical page address information; the physical page address information which the address translation pair of the address translation buffer keeps doubles as a tag of the cache memory; and an action of the corresponding way of the cache according to a hit signal from the address translation buffer is selected.

A data processor according to another aspect of the invention has an address translation buffer and a cache memory in a set associative form having ways, wherein the address translation buffer has an address translation pair keeping virtual page address information and physical page address information; data in a physical address space specified by the physical page address information which the translation pair of the address translation buffer keeps is stored in the corresponding way of the cache memory; and an action of the corresponding way is selected according to a hit signal from the way of the address translation buffer.

A data processor according to another aspect of the invention having a prediction circuit incorporated therein has an address translation buffer and a cache memory in a set associative form having ways, wherein the address translation buffer has an address translation pair keeping virtual page address information and physical page address information, and a prediction circuit for predicting a translation hit in the address translation buffer; the physical page address information which the address translation pair of the address translation buffer keeps doubles as a tag of the cache memory; an action of the corresponding way of the cache is selected according to the prediction by the prediction circuit, and a cache hit is created on condition that the prediction matches up with an actual address translation result.

A data processor according to still another aspect of the invention having a prediction circuit incorporated therein has an address translation buffer and a cache memory in a set associative form having ways, wherein the address translation buffer has an address translation pair keeping virtual page address information and physical page address information and a prediction circuit for predicting a translation hit in the address translation buffer; data in a physical address space specified by the physical page address information which the translation pair of the address translation buffer keeps is stored in the corresponding way of the cache memory; an action of the corresponding way of the cache is selected according to the prediction by the prediction circuit, and a cache hit is created on condition that the prediction matches up with an actual address translation result.

Effects which the representatives of a data processor disclosed herein offer will be described below briefly.

In regard to a data processor having a set associative cache memory and an address translation buffer, it is possible to reduce electric power consumption by the set associative cache memory. This is because an action for a data array in a set associative cache memory is selected for only one way according to a translation hit signal of TLB.

### BRIEF DESCRIPTION OF THE DRAWINGS

FIG. 1 is a block showing examples of ITLB and ICACHE in detail.

FIG. 2 is a block diagram of a data processor in association with an embodiment of the invention.

FIG. 3 is an address map exemplifying relations between data in a main memory and data in a cache memory in an arrangement such that an address translation buffer and a cache memory are linked in close connection and operated as typified by the arrangement shown in FIG. 1.

FIG. 4 is a flowchart showing the flows of actions of ITLB and ICACHE.

FIG. 5 is a flowchart showing the flow of TLB rewrite control.

FIG. 6 is a flowchart showing the flow of cache rewrite control.

FIG. 7 is a block diagram showing examples of ICACHE and ITLB using the result of prediction on an address translation hit, in detail.

FIG. 8 is a block diagram showing a cache memory in a form such that all the ways are indexed in parallel, as a comparative example.

FIG. 9 is an address map exemplifying relations between data in the cache memory shown in FIG. 8 and data in the main memory.

### DETAILED DESCRIPTION OF THE PREFERRED EMBODIMENT

### Data Processor

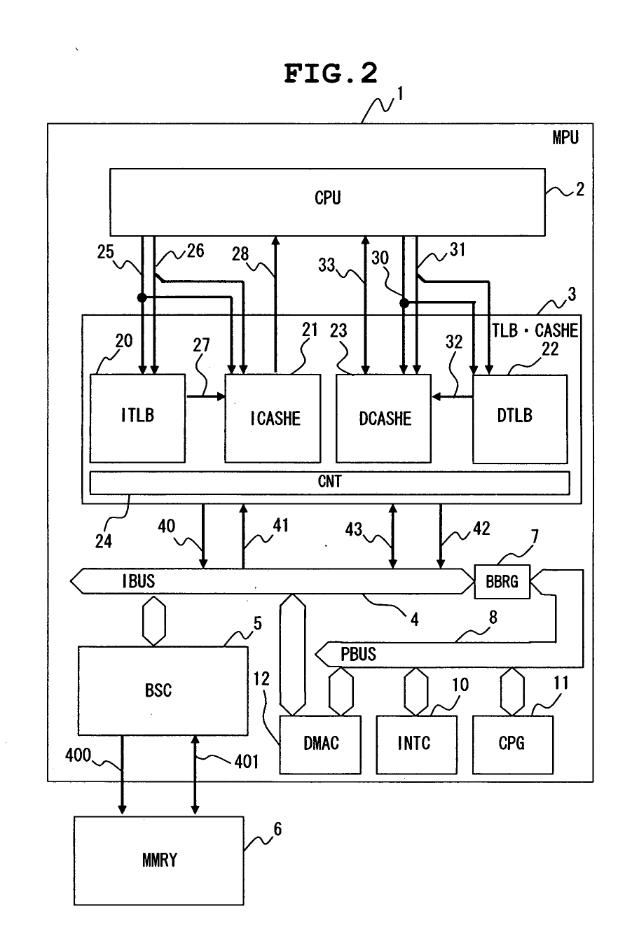

FIG. 2 shows a data processor in association with an embodiment of the invention. The data processor (MPU) 1 shown in the drawing is not particularly limited, but it is formed in a single semiconductor substrate (semiconductor chip) of e.g. monocrystalline silicon by means of a known manufacturing technique for semiconductor integrated circuits. The data processor 1 has e.g. a central processing unit (CPU) 2 as a data processing unit. The central processing unit 2 is connected to an internal bus (IBUS) 4 through an address translation buffer & cache unit (TLB•CACHE) 3. There is no restriction particularly, a bus protocol for a split transaction bus is adopted for the internal bus 4. To the internal bus 4 is connected a bus controller (BSC) 5 which performs external bus control or external memory interface control. In the drawing, the bus controller 5 is connected with a main memory (MMRY) 6 composed of a synchronous DRAM or the like. An external circuit to be connected to the bus controller is not limited to a memory, and an LSI, e.g. an LCDC or a peripheral circuit, may be connected to the bus controller otherwise. Also, the internal bus 4 is connected with a peripheral bus (PBUS) 8 through a bus bridge circuit (BBRG) 7. To the peripheral bus 8, peripheral circuits including an interrupt controller (INTC) 10 and a clock pulse generator (CPG) 11 are connected. Further, a direct memory access controller (DMAC) 12 is connected to the peripheral bus 8 and the internal bus 4, and performs data transfer control between modules.

The CPU 2 is not particularly limited, however it has: an operation part which includes a general purpose register and an arithmetic and logic unit and performs an operation; and an instruction control part which includes a program counter and an instruction decoder, and fetches and decodes an instruction, controls a procedure for execution of an instruction, and performs operation control.

The address translation buffer & cache unit 3 has: an instruction address translation buffer (ITLB) 20; an instruction cache memory (ICACHE) 21; a data address translation buffer (DTLB) 22; a data cache memory (DCACHE) 23; and a control circuit 24. The ITLB 20 has, as a translation pair, a pair of information composed of a virtual instruction address and a physical instruction address associated with the virtual instruction address. DTLB 22 has a pair of information composed of a virtual data address and a physical data address in associated with the virtual data address, as a translation pair. The translation pairs are copies of parts of page-management information on the main memory 6. ICACHE 21 has a copy of an instruction, i.e. a part of a program kept in a program region on the main memory. The DCACHE 23 has a copy of a part of data kept in a work region on the main memory.

When fetching an instruction, the CPU 2 asserts an instruction fetch signal 25 to ITLB 20 and ICACHE 21, and outputs a virtual instruction address 26. In response to a translation hit for a virtual address, ITLB 20 outputs a virtual address translation hit signal 27 to ICACHE 21. ICACHE 21 outputs an instruction 28 according to a virtual instruction address to the CPU 2. When fetching data, CPU 2 asserts a data fetch signal 30 to DTLB 22 and DCACHE 23, and outputs a virtual data address 31 to them. In response to a translation hit for a virtual address, DTLB 22 outputs a virtual address translation hit signal 32 to DCACHE 23. In read access, DCACHE 23 outputs data 33 depending on a virtual data address to the CPU 2. In write access, DCACHE 23 writes data 33 from the CPU 2 on a cache line depending on a virtual data address. The control circuit 24 responds to the occurrence of a translation miss in ITLB 20 and DTLB 22 and performs e.g. the control to serve the CPU 2 with a notice of a TLB exceptional treatment request. Also, the control circuit 24 performs e.g. the replace control of cache entry in response to the occurrence of a cache miss in ICACHE 21 and DCACHE 23.

The address translation buffer & cache unit 3 outputs a physical instruction address 40 to the internal bus 4, and accepts input of an instruction 41 therethrough. Also, the unit 3 outputs a data address 42 to the internal bus 4, and presents an output of data 43 to and accepts input thereof through the internal bus 4.

### Address Translation Buffer & Cache Unit

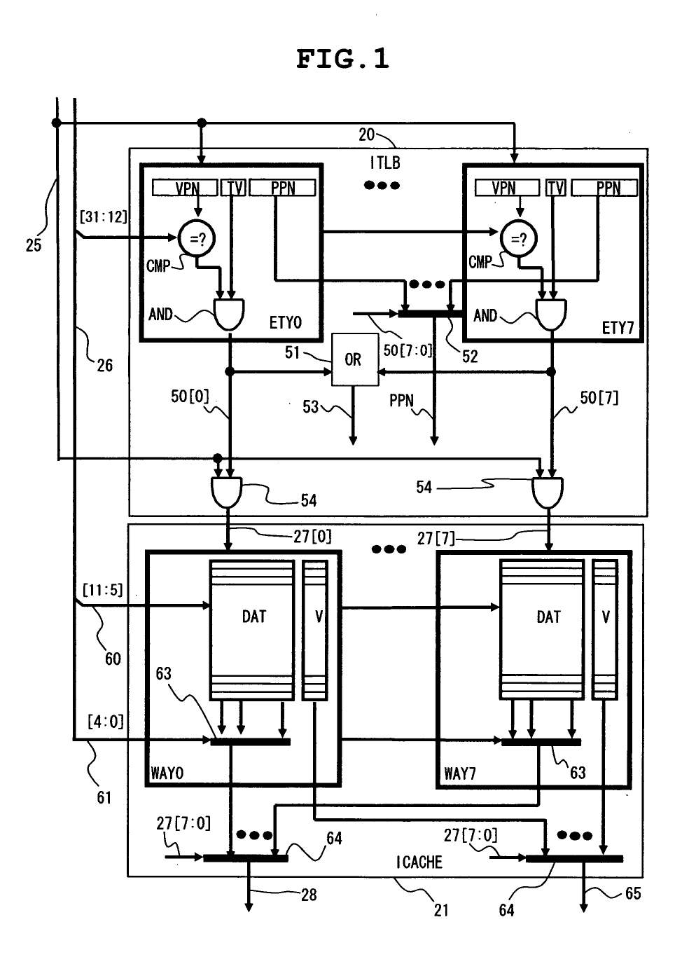

Referring to FIG. 1, examples of ITLB and ICACHE are shown in detail. Here, ITLB 20 has e.g. a full associative configuration of eight entries, and ICACHE 21 has e.g. a set associative configuration of eight ways.

As for ITLB 20, two entries ETY0 and ETY7 are shown representatively. For a full associative configuration of eight entries, each entry can be referred to as “way.” However, the word “entry” is used here in order to differentiate it from the way of a cache memory. Each entry has entry fields to keep a virtual page address (VPN), an effective bit (TV) of the entry, and a physical page address (PPN). VPN and PPN constitute a translation pair. In this example, the page size, which is a unit for address translation by ITLB 20, is four kilobytes, and the virtual address space is a 32-bit address space. The bit width of VPN and PPN is twenty bits between thirteenth and thirty-second bits ([31:12]). In each entry, CMP shows a comparison means and AND shows a logical AND gate, functionally. For a memory of the full associative configuration, it is possible to adopt a memory cell having a function for comparison in bits. In this case, the memory cell may take charge of the comparison and logical AND functions in bits.

When the CPU 2 issues a virtual instruction address 26, the comparison means CMP compares a virtual page address [31:12] in the instruction address with the VPN ([31:12]). When the virtual page address agrees with VPN, and the effective bit TV is one (1), i.e. at an effective level, an entry translation hit signal 50 [0] in the entry ETY0 becomes a logical value one (1) which means a hit. A TLB multi-hit state such that two or more signals of entry translation hit signals 50 [7:0] from the entries take the logical value 1 simultaneously does not occur usually. In a case where the TLB multi-hit state is caused, a measure including detecting the state and serving the CPU 2 a notice of a multi-hit exceptional treatment request will be taken.

A logical OR circuit (OR) 51 produces the logical OR of signals 50 [7:0] of eight lines to generate a translation hit signal 53. The control circuit 24 accepts input of a translation hit signal 50, and sends out a TLB miss exceptional request to CPU 2 on receipt of a notice of TLB miss. One of PPNs in the entries is selected according to entry translation hit signals 50 [7:0] in a selector 52 and output as a physical page address. The physical page address is output to the internal bus 4 as a physical page address constituting the physical address 40 indicated by the numeral 40 in FIG. 2, as required. The AND gate 54 produces a logical product of the entry translation hit signal 50 [7:0] and the instruction fetch signal 25. The logical product is supplied to the instruction cache memory 21 as a virtual address translation hit signal 27 [7:0].

The instruction cache memory 21 has eight ways WAY0-WAY7. It is noted here that when the ways WAY0-WAY7 are referred to as a whole or individually, they are also denoted by the way WAY, simply. The ways WAY0-WAY7 each have a data field DAT and an effective bit field V. The cache capacity of the data field of each way WAY is four kilobytes, which is coincident with the page size. In regard to the cache line size of the data field DAT, an example of 32 bytes is shown. Low-order addresses [11:5] of a virtual address are offered as an index address 60 to the instruction cache memory 21. Low-order addresses [4:0] of the virtual address are handled as a in-line offset address 61, and used to select a data position within 32 bytes in one line. For the selection, a selector 63 is used. The actions of the eight ways WAY0-WAY7 are directed by means of virtual address translation hit signals 27 [7:0] individually. Specifically, the memory actions of the ways WAY0-WAY7 are selected when the corresponding virtual address translation hit signals 27 [7:0] result from a translation hit. Then, the following are made possible for the way WAY, the memory action of which is selected: addressing by use of an index address, and the like; selection of a memory cell; readout of stored information from a selected memory cell; and storing of information in a selected memory cell. Therefore, even when there is an instruction access request, the way WAY is not activated unless the corresponding virtual address translation hit signal 27 [7:0] results from a translation hit. As the virtual address translation hit signals 27 [7:0] are each a translation hit signal in virtual pages, only one of the virtual address translation hit signals 27 [7:0] is made the logical value one (1) (i.e. translation hit value), and therefore the number of ways to be made to work is limited to one. That is, only one way WAY corresponding to a virtual page involved in a hit of address translation by TLB is made to work, and all the ways are never made to work in parallel. This allows a needless power consumption to be held down.

In the way WAY which has been activated, cache lines corresponding to an index address 60 are selected out of the data field DAT and effective bit field V, and the data and effective bit are read out therefrom. The data thus read out is selected according to an offset address 61 by the selector 63. The data output by the selectors 63 and the effective bits read out of the ways are selected and output by a selector 64 which performs a selecting operation according to the virtual address translation hit signals 27 [7:0]. The effective bit selected by the selector 64 is supplied to the control circuit 24. The control circuit 24 regards the effective bit as a cache hit signal 65. When the cache hit signal results from a cache hit, i.e. when the effective bit takes on the logical value indicative that the effective bit is valid, the data selected by the selector 64 is supplied to the CPU 2 as cache data 28. In the case of cache miss, the control circuit 24 accesses the main memory 6 through the bus controller 5, performs the control to take a corresponding instruction into the cache line, and supplies the CPU 2 with the instruction thus taken.

While ITLB and ICACHE in connection with an instruction have been described above with reference to FIG. 1, data-related DTLB and DCACHE may be arranged likewise. In a data-related case, a write access can take place, too. However, there is no need to perform handling particularly different from the handling performed on a conventional cache memory except selection of ways. This applies to the case where integrated TLB and integrated cache memory arrangements with no differentiation between an instruction and data are adopted. While details are to be described later, handling of a cache memory will be needed in connection with a TLB miss.

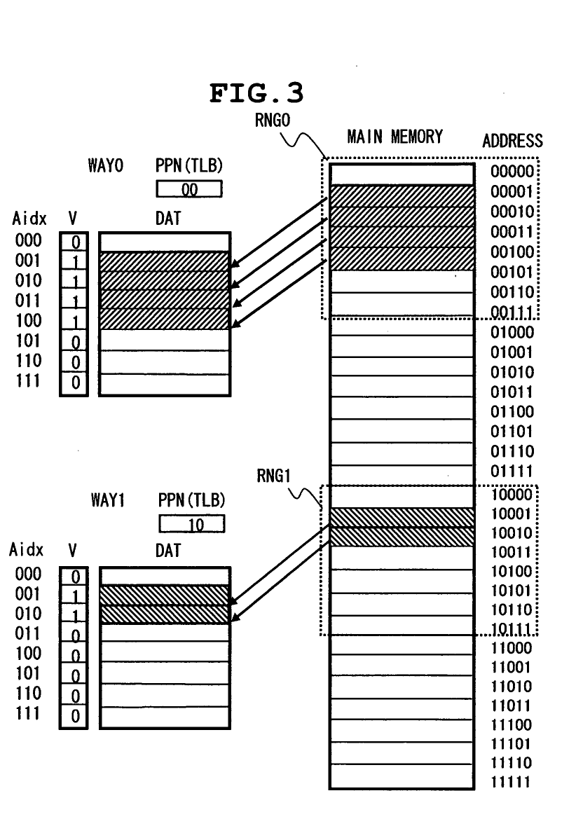

Referring to FIG. 3, there are exemplified relations between main memory data and cache memory data in an arrangement such that an address translation buffer and a cache memory are linked in close connection and operated as typified by the arrangement shown in FIG. 1. Here, for the sake of simplicity, PPN is configured of two bits, and the page size is of a 3-bit area. The way of the cache memory has eight cache lines. The index address Aidx is configured of three bits. In the drawing, PPN of TLB corresponding to the way WAY0 has a page number of 00, and PPN of TLB corresponding to the way WAY1 has a page number of 10. In this case, it is possible to store a range RNG0 of main memory's memory addresses extending from 00000 to 00111, inclusive in the way WAY0 of the cache memory. In the way WAY1, a range RNG1 of the memory addresses extending from 10000 to 10111, inclusive can be stored. As stated above, at some point, only a memory region stored in the TLB and targeted for address translation can be stored in the corresponding way of the cache memory. Because of such relation, the activation of a memory action can be decided for each way of the cache memory by use of a virtual address translation hit signal for each entry to the TLB. Data registration to the cache memory is performed in line sizes. The cache memory keeps an effective bit for each of the sizes. When effective data is registered on the cache, the effective bit is made the logical value of one (1), thereby showing that the data is valid.

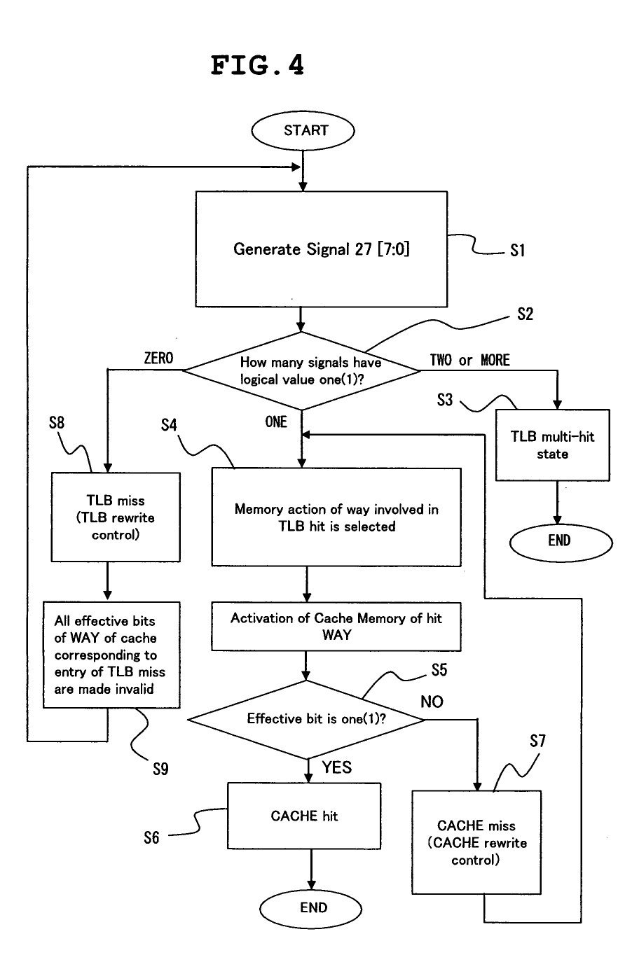

Referring to FIG. 4, there are exemplified the flows of actions of ITLB and ICACHE. A high-order address [31:12] of an instruction virtual address issued by CPU 2 is compared with VPN of each entry of the instruction TLB. A logical product of the result of the comparison and an effective bit of the entry is taken thereby to generate a virtual address translation hit signal 27 [7:0] of each entry (S1). Of the virtual address translation hit signals 27 [7:0], it is judged how many signals have the logical value 1 (S2). When two or more signals have the logical value 1, the CPU 2 accepts a notice of the TLB multi-hit state (S3). When only one signal has the logical value 1, the memory action of the way involved in the hit is selected, and indexed data and an effective bit are read out from the relevant way (S4). It is judged whether the logical value of the effective bit thus read out is one (S5). When the effective bit is valid (i.e. the bit has the logical value 1), the read data is supplied to the CPU (S6). When the effective bit is invalid, an action to fill a cache line or the like is taken in response to the cache miss through cache rewrite control (S7). When it is judged at Step S2 that all the signals have the logical value zero (0), a TLB miss is regard as having occurred, and then a TLB miss exceptional treatment request for addition or replacement of a TLB entry is issued to the CPU 2, whereby TLB rewrite control is performed (S8). In this process, the control part 24 rewrites the effective bits of all the ways of the cache memory to which a TLB entry subjected to the rewrite corresponds into invalid level ones (S9). After that, the process steps starting from the action of comparison of each entry of TLB with a virtual page address VPN (S1) are repeated.

In the case of a data cache memory which is required to cope with a write access, if the cache memory has data of a data field which has to be copied back, the control circuit 24 performs write back to the main memory when nullifying a data field of a way of a cache memory corresponding to an entry to be replaced (S9). However, this is not particularly shown in the drawing.

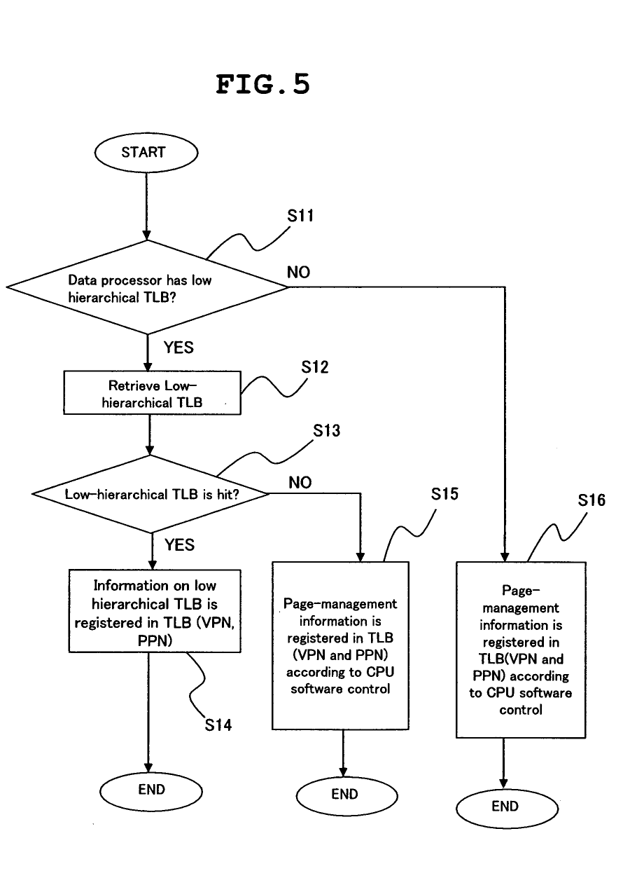

Referring to FIG. 5, there is exemplified the flow of TLB rewrite control. The rewrite control flow depends on whether or not the data processor has a low hierarchical TLB (S11). When the data processor has a low hierarchical TLB, the low hierarchical TLB is retrieved (S12). It is judged whether the retrieved low hierarchical TLB is targeted for a translation hit (TLB hit) with respect to the virtual page address in connection with the TLB miss (S13). In the case where the retrieved low hierarchical TLB is targeted for TLB hit, VPN and PPN of a translation pair of the relevant low hierarchical TLB are registered as entries of the TLB involved in the miss (S14). In the case where the low hierarchical TLB is found to be involved in the miss at Step S13, i.e. the case where the data processor has a low hierarchical TLB and a TLB miss is also detected for the low hierarchical TLB, the CPU accepts a notice of the TLB miss, the page management information managed by the main memory is registered in (VPNs, PPNs of) both the high and low hierarchical TLBs involved in the miss and made valid according to software control (S15). When there is no low hierarchical TLB, the CPU accepts a notice of TLB miss exception, and the page-management information managed by the main memory 6 is registered in TLB (VPN and PPN) involved in the miss and made valid according to software control.

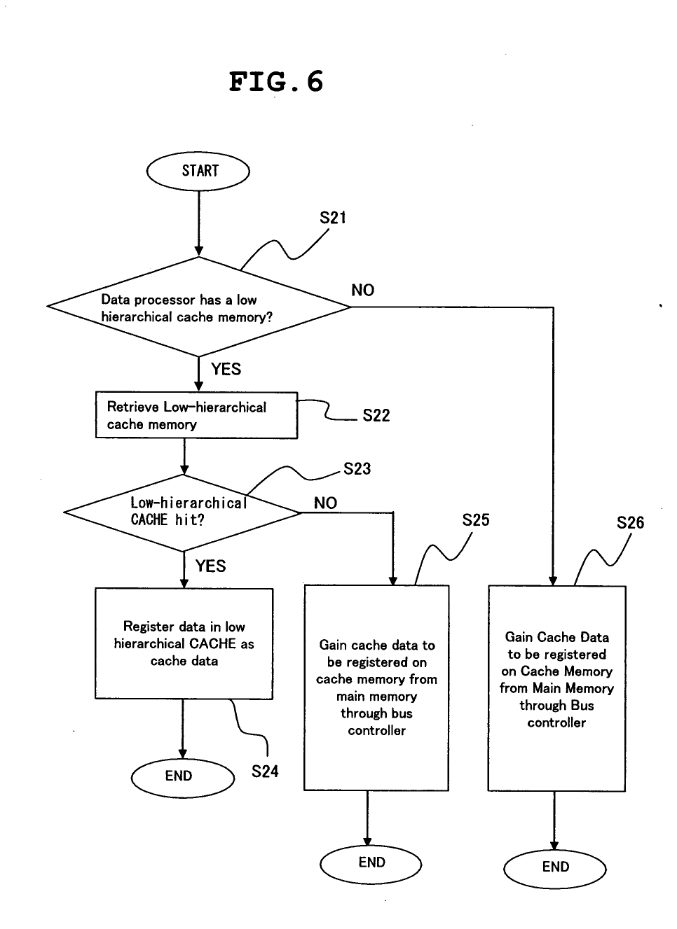

Referring to FIG. 6, there is exemplified the flow of cache rewrite control. In the case where a hit is made with respect to TLB, but the effective bit of the corresponding way of the cache takes a logical value of zero (0) (i.e. invalid level), a cache miss is detected. In this case, as described concerning Step S7 with reference to FIG. 4, cache rewrite control is performed. Rewrite of the cache is to update only one line involved in the cache miss.

The control depends on whether or not the data processor has a low hierarchical cache memory (S21). When the data processor has a low hierarchical cache memory, the low hierarchical cache memory is retrieved (S22). In the case where the low hierarchical cache memory is involved in a cache hit, the cache data in connection with the hit is registered on a high hierarchical cache memory to make the effective bit the logical value of one (1) (S24). When there is a low hierarchical cache, and the low hierarchical cache is also involved in the cache miss, the bus controller 5 accepts a notice of the cache miss and is made to access the main memory 6. The data thus gained from the main memory 6 is registered on both high and low hierarchical cache memories, and the effective bit is made the logical value of one (1) (S25). At this Step, it is also possible to select the alternative not to register the data on the low hierarchical cache memory. In the case where there is no low hierarchical cache memory, the bus controller 5 accepts a notice of the cache miss, and is made to access the main memory 6. The data thus gained from the main memory 6 is registered on the cache memory and the effective bit is made the logical value one (1). Then, the cache rewrite control is terminated (S26).

After rewrite of the cache memory, right data can be supplied to the CPU 2. In this case, it is possible to repeat the process steps from the action of comparison of each entry of TLB with VPN (S1). Also, after the holding of a virtual address translation hit signal 27 [7:0], the process may be resumed from the action of readout from the corresponding cache way. Also, it is possible to perform the control to register the data that the CPU 2 requires on the cache memory in parallel with supplying the data to the CPU 2, concurrently with data registration onto the cache memory.

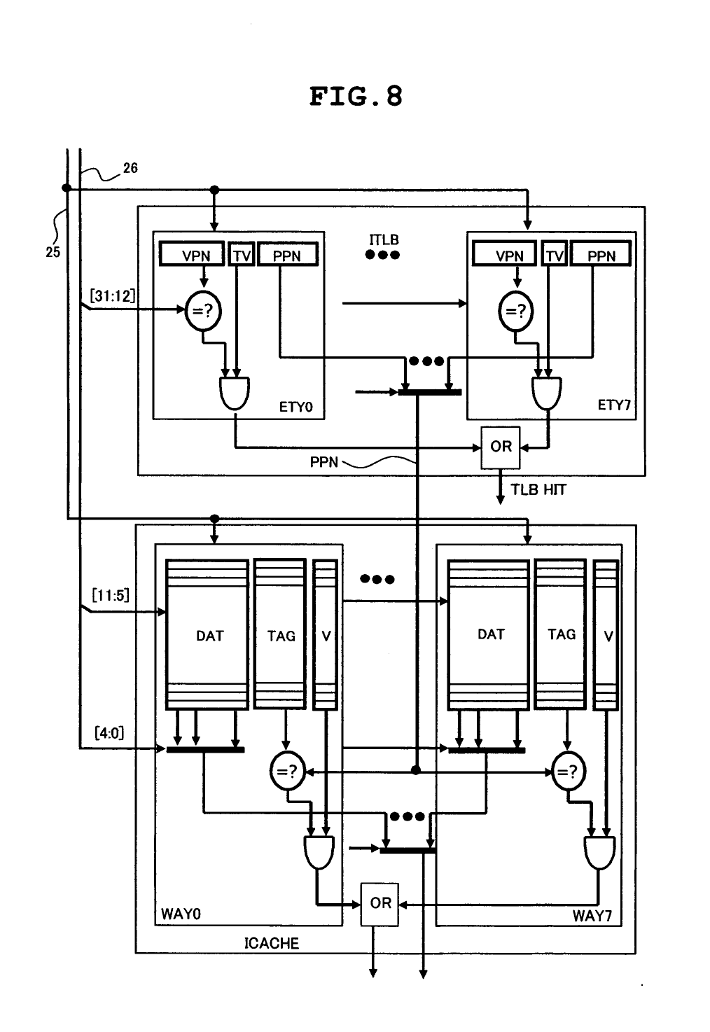

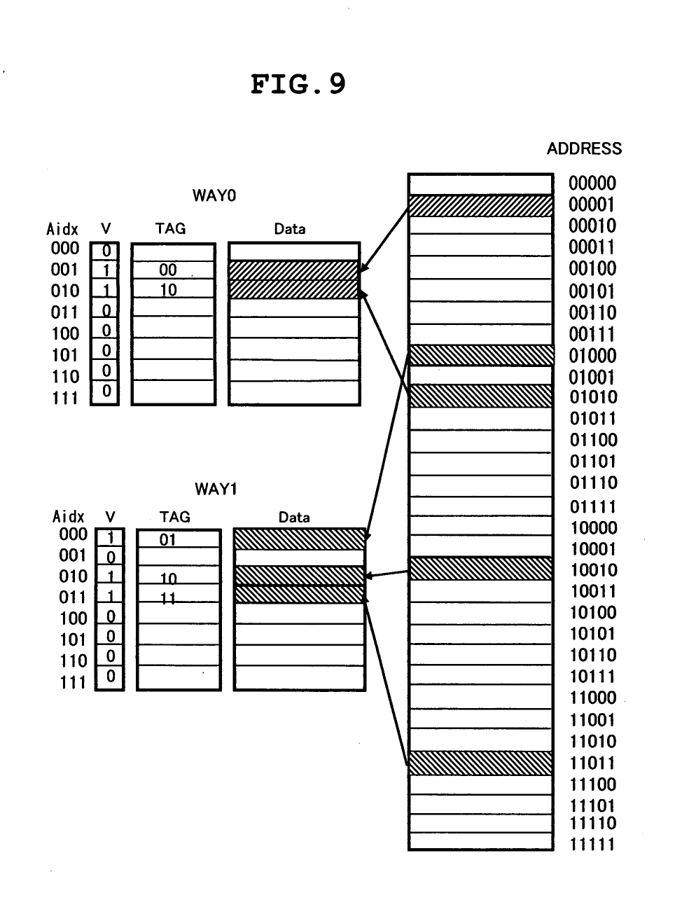

Referring to FIG. 8, there is shown a cache memory in a form such that all the ways are indexed in parallel as a comparative example. As in FIG. 8, ICACHE has an address tag field TAG. Further, as in FIG. 8, in ICACHE on receipt of an instruction access request by means of a signal 25, actions of all the ways WAY0-WAY7 are selected followed by starting an action of indexing, in parallel with an action of address translation of ITLB. A tag of the indexed cache line is compared with a physical page address supplied by ITLB. The cache data of the way for which an agreement between the cache line tag and physical page address is found will be regarded as being data involved in a cache hit. FIG. 9 exemplifies relations between data in the cache memory shown in FIG. 8 and data in the main memory. Here, as in the case shown in FIG. 3, for the sake of simplicity, PPN is configured of two bits, and the page size is of a 3-bit area. The way of the cache memory has eight cache lines. The index address Aidx is configured of three bits.

As described above, the memory action of the corresponding cache way is started in response to an address translation hit signal generated for each entry of TLB as typified by virtual address translation hit signals 27 [7:0] in the data processor 1. Therefore, all the cache ways never start the action of indexing in parallel. ICACHE and DCACHE eliminate the need for a tag memory for the cache, and therefore do not need any power to access the tag memory itself. Hence, in contrast to a cache memory having a set associative configuration according to a conventional art, low power consumption can be achieved. In estimation of the effect, it is assumed, in consideration of bit widths of the tag field and data field of the cache memory, that the power consumption ratio of a tag field vs. a data field in one cache way is 1:2. In this case, the power consumption ratio of a set associative cache memory according to a conventional art vs. a selectively working type cache memory of a way in close connection with TLB typified by ICACHE is 12:2 approximately. Hence, it can be estimated that the power consumption of a cache memory can be reduced by about 83%.

### Cache Unit using Result of Prediction on Address Translation Hit

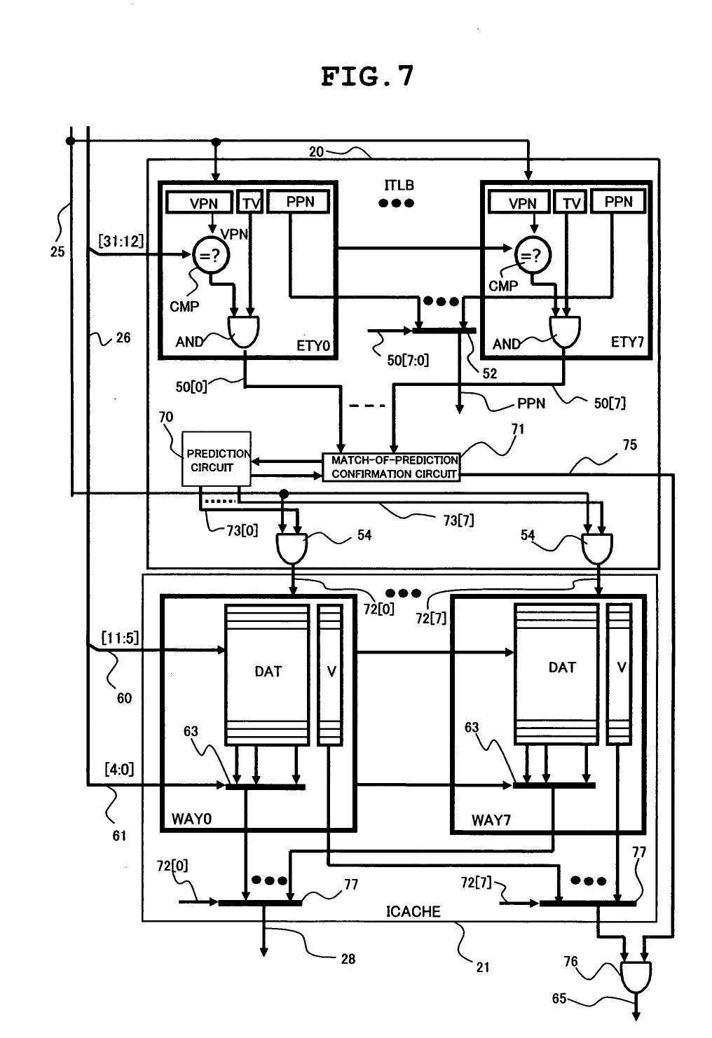

Referring to FIG. 7, there is shown examples of ICACHE and ITLB using the result of prediction on an address translation hit, in detail. Here, ITLB 20 has e.g. a full associative configuration of eight entries, and ICACHE 21 has e.g. a set associative configuration of eight ways, as in the case shown in FIG. 1. The configuration is different from that shown in FIG. 1 in the following point. That is, a prediction circuit 70 and match-of-prediction confirmation circuit 71 are added, and the action of the way WAY is selected according to a virtual address translation hit prediction signal 72 [7:0] so that a cache hit 65 is created on condition that the prediction concerning an address translation hit matches with the result of actual address translation. The prediction circuit 70 holds the result of the last address translation and outputs the result as a prediction signal 73 [7:0]. The AND gate 54 produces a logical product of the prediction signal 73 [7:0] and the instruction fetch signal 25, and the resulting logical product signal will make a virtual address translation hit prediction signal 72 [7:0]. The memory actions of the ways WAY0-WAY7 of ICACHE 21 are started when the corresponding virtual address translation hit prediction signals 72 [7:0] have the logical value of one (1). In short, as to the activation control for the ways WAY0-WAY7 of ICACHE 21, the virtual address translation hit prediction signals 72 [7:0] have the same functions as those the virtual address translation hit signals 27 [7:0] shown in FIG. 1 have.

The match-of-prediction confirmation circuit 71 receives entry translation hit signals 50 [7:0] as the results of actual address translations in the entries ETY0-ETY7. The match-of-prediction confirmation circuit 71 judges whether the value of the prediction signal 73 [7:0] that the prediction circuit 70 holds matches with the entry translation hit signal 50 [7:0] that the prediction circuit 70 has newly received, and then outputs a signal 75 resulting from the judgment. Concurrently, the match-of-prediction confirmation circuit 71 makes the prediction circuit 70 hold the value of the newly received entry translation hit signal 50 [7:0] as a new result of prediction, thereby to make the value of the entry translation hit signal 50 [7:0] available for a next cache action. The AND gate 76 produces a logical product of the signal 75 resulting from the judgment, which shows whether the prediction is right or wrong, and the effective bit selected by the selector 77. The logical product signal thus produced is regarded as a cache hit signal 65.

In comparison to the case shown by FIG. 1 where the corresponding way of the cache is activated by use of the signal 27 [7:0], the way WAY of the instruction cache is activated by using a logical product signal of the prediction signal 73 [7:0] and instruction access signal 25 instead. Therefore, the cache memory 21 can be activated without waiting the determination of the translation hit signal 50 [7:0] in ITLB 20, which enables a high-speed action. Also, in this case, the comparison of VPN on the side of ITLB 20 is performed. Then, at the time when the address translation hit signal 50 [7:0] is determined actually, it is confirmed whether the prediction was right. The result of confirmation of the match of prediction is supplied to the prediction circuit 70 for the result to be reflected in the next prediction. When it is confirmed that the prediction was right, the data and cache hit signal output by ICACHE 21 are right data and a right signal, and used as in the case shown by FIG. 1. In the case where it is confirmed that the prediction was wrong, as the right prediction signal 73 [7:0] has been obtained already this time, a mistake is never made in prediction even when an output of the prediction circuit 70 is used. When the prediction circuit 70 holds a right prediction hit signal, it is possible to resume the control from the reading of the corresponding way WAY of the cache memory 21. As a matter of course, the control to repeat the actions from the comparison of each entry ETY of ITLB 20 with VPN can be performed. This application example has a feature such that effective data in the cache memory can be obtained at a high speed. In addition, the application example has a feature such that the effect of low power consumption can be achieved as in the example stated above. This is because the application example is the same as the above-described example in that one way WAY of the cache memory is activated.

While the invention which the inventor made has been specifically described above based on the embodiments, the invention is not so limited. It is needless to say that various modifications and changes may be made within a scope hereof without departing from the subject matter.

For instance, in the above example, a method using a fixed length address translation (paging method) is cited as an example of a mapping method from a virtual memory to a physical memory. The page size is not limited to four kilobytes, and it may be changed appropriately. The data processor may include a data processing unit such as a floating-point unit or a product-sum operation unit in addition to CPU. Further, the data processor may have another circuit module. The data processor is not limited to a single chip form, and it may be formed in a multichip. Otherwise, the data processor may have a multi-CPU configuration including two or more central processing units.

The invention can be applied to a microcomputer, a microprocessor, and the like, which include an address translation buffer and a cache memory.

What is claimed is:

1. A data processor comprising:
an address translation buffer; and
a cache memory in a set associative form,
wherein the address translation buffer has n entry fields for each storing an address translation pair,
the cache memory has n ways in a one-to-one correspondence with the entry fields,
the n ways each include a data field having a storage capacity equal to a page size which is a unit of address translation,
the address translation buffer outputs a result of associative comparison for each entry field to the corresponding way, and
the way starts a memory action in response to an associative hit of the input associative comparison result.

2. The data processor of claim 1, wherein the address translation pair has information composed of a combination of a virtual page address and a physical page address corresponding to the virtual page address, and
a physical page address of data which the data field keeps is identical with the physical page address which the address translation pair of the corresponding entry field keeps.

3. The data processor of claim 2, wherein there is no need for the cache memory to have an address tag field which would make a mate to the data field.

4. The data processor of claim 3, wherein the address translation buffer compares an input address targeted for the translation with the virtual page address of each entry field, and
the address translation buffer serves the way corresponding to the entry field with a notice of way hit on condition that the entry field matched as a result of the comparison is valid, and
the notice of way hit shows an associative hit, which is a result of the associative comparison.

5. The data processor of claim 1, further comprising a control unit which replaces the entry of the address translation buffer when associative comparisons by the address translation buffer all result in associative miss,
wherein the control unit nullifies a data field of the way of the cache memory corresponding to the entry to be replaced when replacing the entry of the address translation buffer.

6. The data processor of claim 5, wherein the control unit further writes data in the data field targeted for copy back in response to write cache miss of the cache memory with respect to a write access back to a memory on a low hierarchical side when nullifying the data field of the way of the cache memory corresponding to the entry to be replaced.

7. A data processor comprising:
an address translation buffer; and
a cache memory in a set associative form,
wherein the address translation buffer has n entry fields for each storing an address translation pair,
the cache memory has n ways in a one-to-one correspondence with the entry fields,
the ways are each allocated to store data of a physical page address which the corresponding entry field keeps, and
the ways start a memory action on condition that associative comparisons concerning the corresponding entry fields result in an associative hit.

8. The data processor of claim 7, further comprising a control unit which replaces the entry of the address translation buffer when associative comparisons concerning all the entry fields result in associative miss,
wherein the control unit nullifies cache data of the way of the cache memory corresponding to the entry to be replaced when replacing the entry of the address translation buffer.

9. The data processor of claim 8, wherein the control unit further writes data to be copied back in response to write cache miss of the cache memory with respect to a write access back to a memory on a low hierarchical side when nullifying data of the way of the cache memory corresponding to the entry to be replaced.

10. A data processor comprising:
an address translation buffer; and
a cache memory in a set associative form,
wherein the address translation buffer has n entry fields for each storing an address translation pair, and a prediction circuit for predicting the entry field which will make a translation hit at a time of address translation,
the cache memory has n ways in a one-to-one correspondence with the entry fields,
the ways are each allocated to store data placed at a physical page address which the corresponding entry field keeps, and
the ways start a memory action on condition that the corresponding entry field is a prediction region of an address translation hit, and
the cache memory creates a cache hit on condition that prediction on the address translation hit matches up with an actual address translation result.

11. A data processor comprising:
an address translation buffer; and
a cache memory in a set associative form having ways,
wherein the address translation buffer has an address translation pair keeping virtual page address information and physical page address information,
the physical page address information which the address translation pair of the address translation buffer keeps doubles as a tag of the cache memory, and
an action of the corresponding way of the cache according to a hit signal from the address translation buffer is selected.

12. A data processor comprising:
an address translation buffer; and
a cache memory in a set associative form having ways,
wherein the address translation buffer has an address translation pair keeping virtual page address information and physical page address information,
data in a physical address space specified by the physical page address information which the translation pair of the address translation buffer keeps is stored in the corresponding way of the cache memory, and
an action of the corresponding way is selected according to a hit signal from the way of the address translation buffer.

13. A data processor comprising:
an address translation buffer; and
a cache memory in a set associative form having ways,
wherein the address translation buffer has an address translation pair keeping virtual page address information and physical page address information, and a prediction circuit for predicting a translation hit in the address translation buffer,
the physical page address information which the address translation pair of the address translation buffer keeps doubles as a tag of the cache memory,
an action of the corresponding way of the cache is selected according to the prediction by the prediction circuit, and
a cache hit is created on condition that the prediction matches up with an actual address translation result.

14. A data processor comprising:
an address translation buffer; and
a cache memory in a set associative form having ways,
wherein the address translation buffer has an address translation pair keeping virtual page address information and physical page address information, and a prediction circuit for predicting a translation hit in the address translation buffer,
data in a physical address space specified by the physical page address information which the translation pair of the address translation buffer keeps is stored in the corresponding way of the cache memory,
an action of the corresponding way of the cache is selected according to the prediction by the prediction circuit, and
a cache hit is created on condition that the prediction matches up with an actual address translation result.
